(19) United States
(12) Patent Application Publication
(10) Pub. No.: US 2026/0342066 A1
(43) Pub. Date: Oct. 29, 2026

(54) BUSBAR AND POWER CONVERSION DEVICE FOR VEHICLE

(71) Applicant: Hyundai Kefico Corporation, Gunpo (KR)

(72) Inventors: Taehyoung Kim, Gunpo (KR); Seung Hwan Shin, Gunpo (KR)

(21) Appl. No.: 19/462,818

(22) Filed: Jan. 28, 2026

(30) Foreign Application Priority Data
Apr. 29, 2025 (KR) 10-2025-0056073

(51) Int. Cl. H02G 5/06

(52) U.S. Cl. CPC H02G 5/06

(57) ABSTRACT

A busbar assembly for an electric vehicle includes an insulation structure. The busbar assembly includes a conductor device configured to transmit power, an insulation device formed to surround at least a part of the conductor device, and an insulation washer device provided on at least a surface of a first through-portion of the conductor device. Also, the insulation washer device may be provided on the surface that is an inner peripheral surface of the first through-portion. In addition, the conductor device may include a second through-portion provided to be spaced apart from the first through-portion.

### CROSS-REFERENCE TO RELATED APPLICATION

This application claims under 35 U.S.C. §119(a) the benefit of Korean Patent Application No. 10-2025-0056073 filed in the Korean Intellectual Property Office on Apr. 29, 2025, the entire contents of which are incorporated herein by reference.

### BACKGROUND

### A. Technical Field

The present disclosure relates to a busbar and a power conversion device for a vehicle, more particularly, to the busbar provided with an insulation structure, and a power conversion device including the busbar provided in the vehicle.

### B. Description of the Related Art

A busbar is a metal strip or metal bar that serves as a current conductor.

For example, in the case of a power conversion device for an electric vehicle or the like, the power conversion device uses the busbar in order to receive a high voltage, convert the high voltage into a low voltage, and output the converted low voltage to the outside.

FIGS. 1A and 1B (RELATED ART) illustrate an example of a busbar used for a power conversion device in the related art.

With reference to FIG. 1A, a substrate 2 provided with a power conversion element is provided in a housing 1 of the power conversion device. A terminal 6 is connected to the substrate 2 through a substrate connection part 7. Power transmitted through the terminal 6 is connected to an output terminal 8 through the busbar 3. One side of the busbar 3 is fixed to one surface of the housing 1 by a fixing bolt 4.

FIG. 1B illustrates a cross-section taken along line 1B-1B in FIG. 1A. With reference to FIG. 1B, the terminal 6, together with the busbar 3, is fixed to a busbar fixing part 1a in the housing 1 by the fixing bolt 4. In order to ensure insulation between the busbar 3 and the housing 1, an insulation sheet 9 is provided between the busbar 3 and the busbar fixing part 1a, and an insulation washer 5 for ensuring insulation from the fixing bolt 4 is provided in a hole of the terminal 6 and a hole of the busbar 3.

The insulation sheet 9, the insulation washer 5, and the like need to be coupled together in order to mount the busbar 3. As a result, there is a problem in that a large number of assembling processes are required, the insulation sheet is likely to be damaged, and the insulation washer having a small size is difficult to handle.

### SUMMARY

The present disclosure provides a busbar capable of improving mounting convenience and achieving an insulation function without using a separate component, such as an insulation sheet or an insulation washer. According to the present disclosure, a power conversion device includes the busbar.

According to the present disclosure, a busbar assembly for a vehicle includes: a conductor device configured to transmit power; an insulation device formed to surround at least a part of the conductor device; and an insulation washer device provided on at least a surface of a first through-portion of the conductor device.

The insulation washer device may be provided on the surface that is an inner peripheral surface of the first through-portion.

The insulation device and the insulation washer device may be made of an insulating resin.

In one aspect, the present disclosure provides a busbar including: a conductor device configured to transmit power; an insulation device formed to surround at least a part of the conductor device; and an insulation washer device provided on an inner peripheral surface of a first through-portion of the conductor device.

In the embodiment, the insulation device and the insulation washer device may be coupled to the conductor device by performing insert-molding in a state in which the conductor device is positioned in a mold.

In addition, the insulation device and the insulation washer device may be made of insulating resin.

In the embodiment, the insulation device may include an end-side insulation portion configured to surround a bottom surface of the first through-portion and surround one side of the busbar at which the first through-portion is positioned.

In addition, an upper surface of the conductor device may be exposed from an upper periphery of the first through-portion to define a terminal seating portion.

In addition, the insulation washer device may protrude by a predetermined height to an upper side of the first through-portion.

In addition, a lower end of the insulation washer device may be connected to the end-side insulation portion.

In the embodiment, an outer peripheral surface of the insulation washer device may guide insertion of a terminal.

In the embodiment, a terminal passage groove may be formed at an upper end of the end-side insulation portion and allow a substrate connection part, which is connected to a terminal seated on the terminal seating portion, to pass therethrough.

In the embodiment, the insulation washer device may be formed with at least one terminal support portion, and the terminal support portion may have a hook structure separated from the insulation washer device in a longitudinal direction of the insulation washer device.

In addition, when a fixing bolt is inserted through the insulation washer device, the terminal support portion may be pressed by a bolt head of the fixing bolt, and the terminal support portion may press a terminal toward the terminal seating portion.

In the embodiment, the conductor device may further include a second through-portion provided to be spaced apart from the first through-portion, and an insulation washer for insulation from a lower part may be inserted into the second through-portion.

A vehicle (e.g., an electric vehicle) may include the busbar/busbar assembly.

According to the present disclosure, a power conversion device for a vehicle includes: a housing; a substrate provided in the housing; and a busbar assembly being electrically connected to the substrate, wherein the busbar assembly comprises: a conductor device configured to transmit power; an insulation device formed to surround at least a part of the conductor device; and an insulation washer device provided on at least a surface of a first through-portion of the conductor device.

The insulation washer device may be provided on the surface that is an inner peripheral surface of the first through-portion.

The conductor device may include a second through-portion provided to be spaced apart from the first through-portion.

According to another aspect, the present disclosure provides a power conversion device including: a housing; a substrate provided in the housing; and a busbar electrically connected to the substrate.

According to the present disclosure, the insulation device is formed on the busbar by insert-injection-molding, such that it is not necessary to provide a separate insulation sheet during a process of mounting the busbar. Further, the insulation washer device is formed together with the insulation device, such that it is not necessary to provide a separate insulation washer.

In addition, according to the present disclosure, the terminal support portion is formed on the insulation washer device, such that the terminal may be tightly attached to the busbar in a state in which the terminal is insulated from the fixing bolt when the fixing bolt is coupled, thereby providing a power product with improved reliability.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1A and 1B (RELATED ART) are views illustrating an example of a busbar used for a power conversion device in the related art.

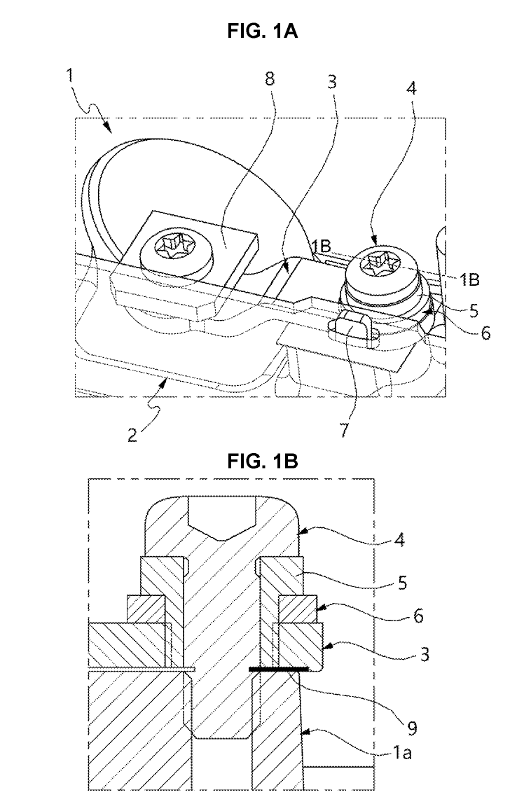

FIG. 2 is a perspective view illustrating a busbar according to an embodiment of the present disclosure.

FIG. 3 is a top plan view illustrating the busbar according to the embodiment of the present disclosure.

FIG. 4 is a perspective view illustrating a conductor device provided in the busbar according to the embodiment of the present disclosure.

FIG. 5 is a cross-sectional view (cross-sectional view taken along line 5-5 in FIG. 2) illustrating the busbar according to the embodiment of the present disclosure.

FIG. 6 is a view illustrating an example in which the busbar according to the embodiment of the present disclosure is mounted in a power conversion device.

FIGS. 7A and 7B are views illustrating a state in which the busbar is positioned in a housing during a process of mounting the busbar according to the embodiment of the present disclosure.

FIGS. 8A and 8B are views illustrating a state in which the busbar is positioned in the housing and a terminal is coupled during the process of mounting the busbar according to the embodiment of the present disclosure.

FIGS. 9A and 9B are views illustrating a state in which a fixing bolt is coupled during the process of mounting the busbar according to the embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

It is understood that the term "vehicle" or "vehicular" or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms "a," "an" and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. In addition, in the description of the present disclosure, the specific descriptions of publicly known related configurations or functions will be omitted when it is determined that the specific descriptions may obscure the subject matter of the present disclosure. Further, the exemplary embodiments of the present disclosure will be described below, but the technical spirit of the present disclosure is not limited thereto and may, of course, be modified and variously carried out by those skilled in the art.

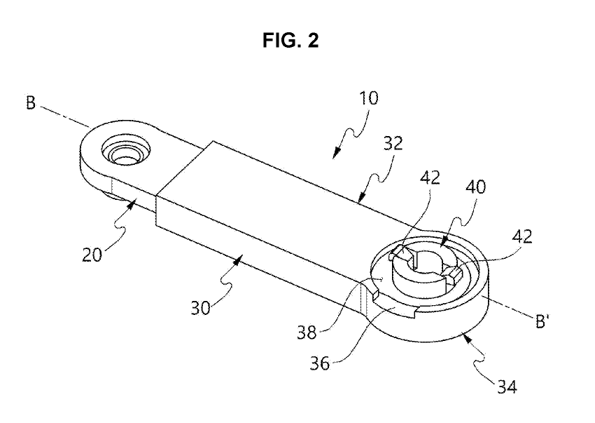

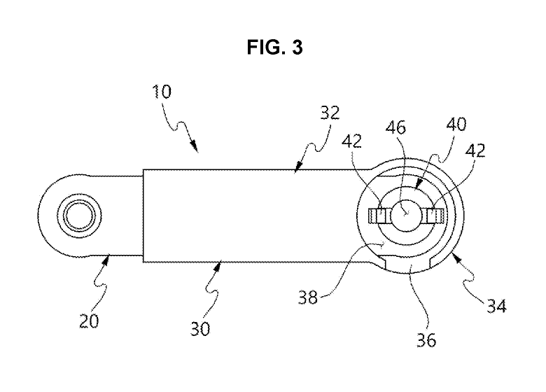

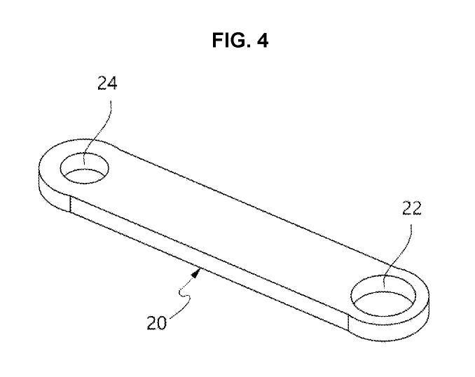

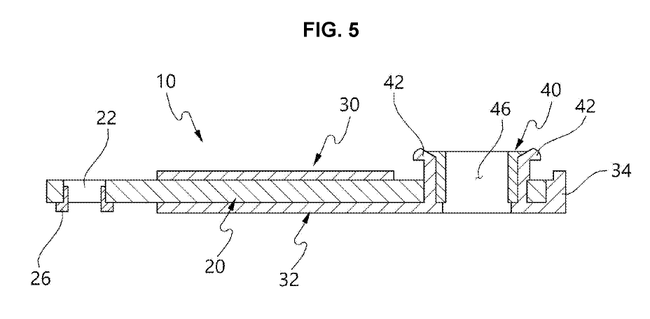

FIG. 2 is a perspective view illustrating a busbar according to an embodiment of the present disclosure, and FIG. 3 is a top plan view illustrating the busbar according to the embodiment of the present disclosure. FIG. 4 is a perspective view illustrating a conductor device provided in the busbar according to the embodiment of the present disclosure, and FIG. 5 is a cross-sectional view (cross-sectional view taken along line 5-5 in FIG. 2) illustrating the busbar according to the embodiment of the present disclosure.

A busbar 10 according to an embodiment of the present disclosure includes a conductor device 20 made of conductive metal to transmit power, an insulation device 30 shaped to cover at least a part of the conductor device 20, and an insulation washer device 40 provided in a fixing part of the busbar 10. As provided herein, the term "busbar" generally refers to a metal strip or metal bar that serves as a current conductor, but may include additional insulation components as provided herein. In addition, the term "busbar assembly" is used synonymously with "busbar," and may refer to a busbar with multiple components/devices/parts.

With reference to FIG. 4, the conductor device 20 may be provided in the form of a bar having a predetermined thickness and include a first through-portion 22 and a second through-portion 24 provided at two opposite ends of the conductor device 20.

The insulation device 30 and the insulation washer device 40 may be provided on the conductor device 20 by insert-molding. In the embodiment, the insulation device 30 and the insulation washer device 40 may be coupled to the conductor device 20 by positioning the conductor device 20 in a mold and then supplying insulating resin into the mold.

With reference to FIGS. 2, 3, and 5, the insulation device 30 is formed to surround at least a part of the conductor device 20. In the embodiment, the insulation device 30 may be formed on at least a part of a bottom surface of the conductor device 20 and substituted for an insulation sheet in the related art. The insulation device 30 may further include an end-side insulation portion 34 configured to surround a bottom surface and an outer side of the first through-portion 22. The end-side insulation portion 34 may be configured to surround the bottom surface of the first through-portion 22 and an outer side of one end of the conductor device 20.

The end-side insulation portion 34 may be formed up to an upper periphery of the first through-portion 22. A terminal seating portion 38, which is an upper surface of the conductor device 20, is exposed from an upper peripheral surface of the first through-portion 22. That is, the terminal seating portion 38 is not coated with an insulating material, such that a terminal 6 may be seated on the terminal seating portion 38 and connected to the conductor device 20. In the embodiment, a terminal passage groove 36 is formed in the end-side insulation portion 34 at one side of the terminal seating portion 38. The terminal passage groove 36 may be formed as a groove in which a substrate connection part 7 connected to the terminal 6 is seated. In the embodiment, the terminal 6 may be a ring terminal having a ring shape. Any terminal may be applied as long as the terminal may be used for electrical connection between a substrate 2 and the busbar 10 according to the present disclosure.

The insulation washer device 40 is provided in the first through-portion 22 and extends from the end-side insulation portion 34 to an upper side of the first through-portion 22 through an inner peripheral surface of the first through-portion 22. The insulation washer device 40 may be formed together with the insulation device 30 and the end-side insulation portion 34 when the insulation device 30 and the end-side insulation portion 34 are formed by insert-molding.

The insulation washer device 40 may have a cylindrical structure attached to the inner peripheral surface of the first through-portion 22. The insulation washer device 40 may include at least one terminal support portion 42. In the embodiment, the terminal support portion 42 may have a hook structure separated from the insulation washer device 40.

In addition, with reference to FIGS. 4 and 5, an insulation washer 26 for ensuring insulation from a lower part may be provided in the second through-portion 24 by being inserted into the second through-portion 24 from below.

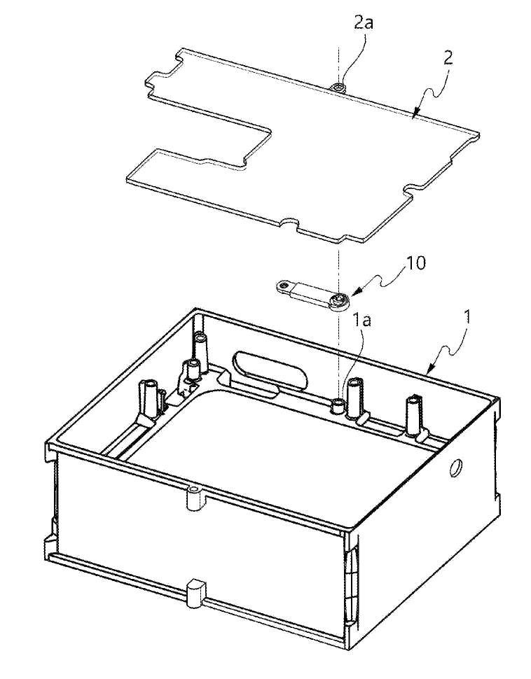

FIG. 6 is a view illustrating an example in which the busbar according to the embodiment of the present disclosure is mounted in a power conversion device.

With reference to FIG. 6, a housing 1 is provided with a busbar fixing part 1a, and one side of the busbar 10 is fixed to the busbar fixing part 1a by a fixing bolt. The substrate 2 mounted with an electronic element may be embedded in the housing 1, and a power supply part 2a may be provided on the substrate 2.

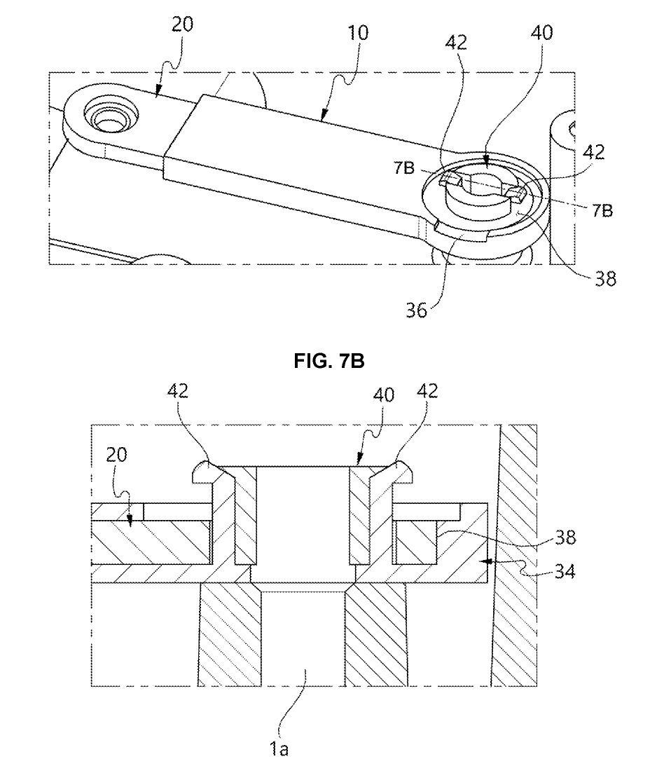

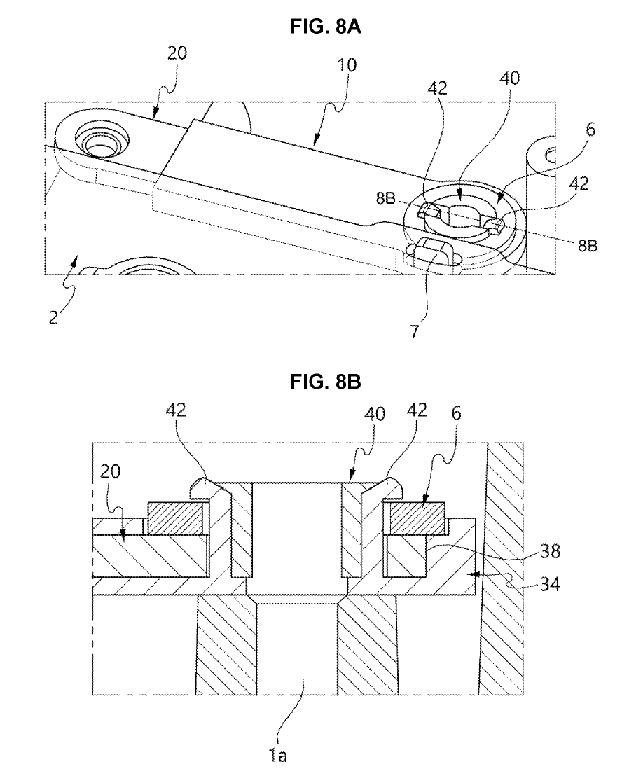

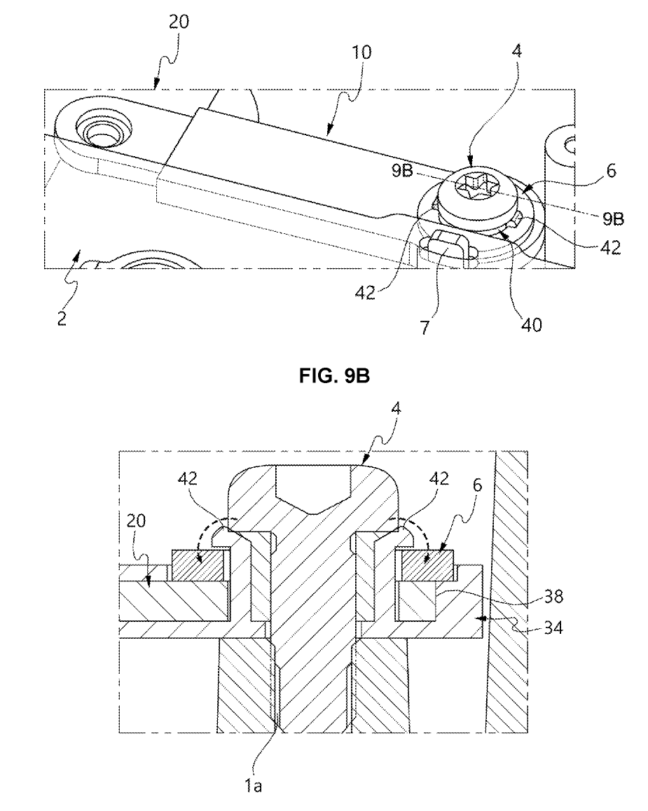

FIGS. 7A and 7B are views illustrating a state in which the busbar is positioned in the housing during a process of mounting the busbar according to the embodiment of the present disclosure, FIGS. 8A and 8B are views illustrating a state in which the busbar is positioned in the housing and the terminal is coupled during the process of mounting the busbar according to the embodiment of the present disclosure, and FIGS. 9A and 9B are views illustrating a state in which the fixing bolt is coupled during the process of mounting the busbar according to the embodiment of the present disclosure.

FIG. 7B is a cross-sectional view taken along line 7B-7B in FIGS. 7A, 8B is a cross-sectional view taken along line 8B-8B in FIGS. 8A, and 9B is a cross-sectional view taken along line 9B-9B in FIG. 9A.

With reference to FIGS. 7A-7B, the busbar 10 is positioned in the housing 1. With reference to FIG. 7B, the insulation washer device 40 and the terminal support portion 42 protrude by predetermined heights to the upper side of the first through-portion 22. Therefore, a stepped portion is formed in a height direction between an upper surface of the terminal seating portion 38 and the insulation washer device 40 and the terminal support portion 42. The insulation device 30 and the end-side insulation portion 34 are formed on a bottom surface of the busbar 10, such that the conductor device 20 of the busbar 10 and the busbar fixing part 1a of the housing 1 are insulated.

With reference to FIG. 8A, the terminal 6 is seated on the terminal seating portion 38, and the substrate connection part 7 connected to the terminal 6 is coupled to the power supply part 2a of the substrate 2.

With reference to FIG. 8B, a bottom surface of the terminal 6 is in contact with the upper surface of the terminal seating portion 38, and the terminal 6 is positioned below the terminal support portion 42.

With reference to FIGS. 9A and 9B, a fixing bolt 4 is inserted into the insulation washer device 40 and screw-coupled to the busbar fixing part 1a. An insulated state between the fixing bolt 4 and the first through-portion 22 is maintained by the insulation washer device 40.

With reference to FIG. 9B, when the fixing bolt 4 is fixed, an upper end of the terminal support portion 42 having a hook shape is pressed by a bolt head of the fixing bolt 4, and a bottom surface of a hook portion of the terminal support portion 42 presses an upper side of the terminal 6. Therefore, the terminal 6 is assuredly tightly attached to the terminal seating portion 38, such that the terminal 6 is prevented from being withdrawn.

The above description is simply given for illustratively describing the technical spirit of the present disclosure, and those skilled in the art to which the present disclosure pertains will appreciate that various modifications, changes, and substitutions are possible without departing from the essential characteristics of the present disclosure. Accordingly, the embodiments disclosed in the present disclosure and the accompanying drawings are intended not to limit but to describe the technical spirit of the present disclosure, and the scope of the technical spirit of the present disclosure is not limited by the embodiments and the accompanying drawings. The protective scope of the present disclosure should be construed based on the following claims, and all the technical spirit in the equivalent scope thereto should be construed as falling within the scope of the present disclosure.

As described above, the exemplary embodiments have been described and illustrated in the drawings and the specification. The exemplary embodiments were chosen and described in order to explain certain principles of the disclosure and their practical application, to thereby enable others skilled in the art to make and utilize various exemplary embodiments of the present disclosure, as well as various alternatives and modifications thereof. As is evident from the foregoing description, certain aspects of the present disclosure are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the disclosure are deemed to be covered by the disclosure which is limited only by the claims which follow.

What is claimed is:

1. A busbar assembly for a vehicle, the busbar assembly comprising:
a conductor device configured to transmit power;
an insulation device formed to surround at least a part of the conductor device; and
an insulation washer device provided on at least a surface of a first through-portion of the conductor device.

2. The busbar assembly of claim 1, wherein the insulation washer device is provided on the surface that is an inner peripheral surface of the first through-portion.

3. The busbar assembly of claim 1, wherein the insulation device and the insulation washer device are made of an insulating resin.

4. The busbar assembly of claim 1, wherein the insulation device and the insulation washer device are coupled to the conductor device by performing insert-molding in a state in which the conductor device is positioned in a mold.

5. The busbar assembly of claim 4, wherein the insulation device and the insulation washer device are made of insulating resin that is formed in the mold.

6. The busbar assembly of claim 1, wherein the insulation device comprises an end-side insulation portion configured to surround a bottom surface of the first through-portion and surround one side of the busbar at which the first through-portion is positioned.

7. The busbar assembly of claim 6, wherein an upper surface of the conductor device is exposed from an upper periphery of the first through-portion to define a terminal seating portion.

8. The busbar assembly of claim 7, wherein the insulation washer device protrudes by a predetermined height to an upper side of the first through-portion.

9. The busbar assembly of claim 8, wherein a lower end of the insulation washer device is connected to the end-side insulation portion.

10. The busbar assembly of claim 8, wherein an outer peripheral surface of the insulation washer device guides insertion of a terminal.

11. The busbar assembly of claim 6, wherein a terminal passage groove is formed at an upper end of the end-side insulation portion and allows a substrate connection part, which is connected to a terminal seated on the terminal seating portion, to pass therethrough.

12. The busbar assembly of claim 6, wherein the insulation washer device is formed with at least one terminal support portion.

13. The busbar assembly of claim 12, wherein the terminal support portion has a hook structure separated from the insulation washer device in a longitudinal direction of the insulation washer device.

14. The busbar assembly of claim 13, wherein when a fixing bolt is inserted through the insulation washer device, the terminal support portion is pressed by a bolt head of the fixing bolt, and the terminal support portion presses a terminal toward the terminal seating portion.

15. The busbar assembly of claim 1, wherein the conductor device further comprises a second through-portion provided to be spaced apart from the first through-portion.

16. The busbar assembly of claim 15, further comprising an insulation washer inserted into the second through-portion.

17. A vehicle comprising the busbar assembly of claim 1.

18. A power conversion device for a vehicle, the power conversion device comprising:
a housing;
a substrate provided in the housing; and
a busbar assembly being electrically connected to the substrate, wherein the busbar assembly comprises:
a conductor device configured to transmit power;
an insulation device formed to surround at least a part of the conductor device; and
an insulation washer device provided on at least a surface of a first through-portion of the conductor device.

19. The busbar assembly of claim 18, wherein the insulation washer device is provided on the surface that is an inner peripheral surface of the first through-portion.

20. The busbar assembly of claim 18, wherein the conductor device further comprises a second through-portion provided to be spaced apart from the first through-portion.
